(19) United States
(12) Patent Application Publication
(10) Pub. No.: US 2020/0142591 A1
(43) Pub. Date: May 7, 2020

(54) SNAPSHOT MANAGING SYSTEM

(71) Applicant: Kaminario Technologies Ltd., Yokne'am ilit (IL)

(72) Inventors: Amir Sasson, Pardes-Hana Karkur (IL); Doron Tal, Haifa (IL); Gilad Hitron, Haifa (IL); Yogev Vaknin, Pardes-Hana Karkur (IL)

(73) Assignee: Kaminario Technologies Ltd., Yokne'am Ilit (IL)

(21) Appl. No.: 16/182,832

(22) Filed: Nov. 7, 2018

(51) Int. Cl. G06F 3/06

(52) U.S. Cl. CPC G06F 3/064; G06F 3/0673; G06F 3/0614

(57) ABSTRACT

A system for finding differences between a given block in two periodical snapshots. Data indicative of a coarse grain data structure corresponding to the given logical unit and including a plurality of entries wherein each entry is representative of a write or no-write operation to a respective memory chunk of in the logical unit. Data indicative of at least one bloom filter, each bloom filter includes a plurality of bits wherein each group of bits is representative of a probable false positive write indication or no-write operation to a block in the chunk. In response to a request to compare between a given block in at least two periodic snapshots: an older snapshotⱼ and a younger snapshotₖ, perform: with respect to the block in a chunk, test in a selected bloom filter if the corresponding group of bits is representative of a false positive, and provide “possible snapshots difference” indication.

### FIELD OF THE INVENTION

The presently disclosed subject matter relates in general to snapshots management.

### BACKGROUND

Snapshots are often used in storage systems for backing up data. Periodical snapshots, where a snapshot of the stored data is generated every recurring period of time, are also known. Determining the difference between the data of different snapshots (e.g. the two last snapshots) is needed for various purposes.

### GENERAL DESCRIPTION

The presently disclosed subject matter includes a system and method for determining a difference between different snapshots, each corresponding to the state of the data at different times.

### SUMMARY OF THE INVENTION

In accordance with an aspect of the presently disclosed subject matter, there is provided a system comprising:

a computerized device configured for finding differences between two periodical snapshots; the computerized device comprising at least one computer processor operatively connected to a computer data storage;

data indicative of a coarse grain data structure corresponding to a given logical unit and including a plurality of entries, wherein each entry is representative of a write or no-write operation to a respective memory chunk of a first granularity in the logical unit; each memory chunk includes a plurality of blocks each of a second granularity that is considerably finer than the first granularity;

data indicative of at least one bloom filter, each bloom filter including a plurality of bits, wherein each group of bits is representative of a probable false positive write indication or no-write operation to a block in the chunk; each bloom filter is associated with min timestamp and max timestamp;
the computer processor is configured to:
in response to a write operation performed to a block in a memory chunk constituting a written block in a written memory chunk of a given logical unit,
(i) set in the coarse grain data structure that corresponds to the logical unit, the value of the entry that corresponds to the written memory chunk to be representative of a write operation; and
(ii) set in an active bloom filter of the at least one bloom filter that corresponds to the logical unit, the value of the group of bits that corresponds to the written block being representative of a probable false positive write indication;
the computer system is further configured to, in response to obtaining a periodic snapshotᵢ of the logical unit at a timestamp tᵢ
(iii) store at least the periodic snapshotᵢ, the data representative of the coarse grain data structure at the timestamp tᵢ and the timestamp tᵢ;
   thereby facilitating usage of the course grain data structure at the timestamp tᵢ and a bloom filter of the at least one bloom filter for determining differences between snapshots.

In accordance with an embodiment of the presently disclosed subject matter, there is further provided a system, wherein the computer processor is configured to set in the active bloom filter the value of the group of bits, including
a. calculating a group of key values as corresponding functions of at least a Volume_Id of the given logical unit, address of the given block and last_snapshot_timestamp; and
b. set in the active bloom filter the value of the group of bits according to the keys.

In accordance with an embodiment of the presently disclosed subject matter, there is further provided a system, wherein said group of bits includes any of 1 to 3 bits.

In accordance with an embodiment of the presently disclosed subject matter, there is further provided a system, wherein the bloom filter is associated with at least (i) a Timestamp of the newest set group of bits in the filter (ii) a Timestamp of the oldest set group of bits in the filter and (iii) Number of bits in the bloom filter representative of a probable false positive write indication, and wherein the computer processor is configured to determine an active bloom filter of the at least one bloom filter based on the number of bits representative of a false positive write indication.

In accordance with an embodiment of the presently disclosed subject matter, there is yet further provided a system, the computer processor being configured to determine an active bloom filter if the number of bits representative of a false positive write indication in a previous active bloom filter is larger than Z, where Z is calculated to guarantee error probability that is not less than a given value.

In accordance with an embodiment of the presently disclosed subject matter, there is yet further provided a system, wherein the given value is selected from a range of 15-30%.

In accordance with an aspect of the presently disclosed subject matter, there is yet further provided a system comprising:

a computerized device configured for finding differences between two periodical snapshots; the computerized device comprising at least one computer processor operatively connected to a computer data storage;

data indicative of a coarse grain data structure corresponding to the given logical unit and including a plurality of entries wherein each entry is representative of a write or no-write operation to a respective memory chunk of a first granularity in the logical unit; each memory chunk includes a plurality of blocks each of a second granularity that is considerably finer than the first granularity;

data indicative of at least one bloom filter, each bloom filter including a plurality of bits wherein each group of bits is representative of a probable false positive write indication or no-write operation to a block in the chunk;

the data structure is further configured to store data including a plurality of periodic snapshotsᵢ and associated coarse grain data structure obtained at respective timestamp tᵢ;

the computer processor is configured to:
(i) in response to a request to compare between at least two periodic snapshots: an older snapshotⱼ and a younger snapshotₖ obtained at respective older timestamp tⱼ and younger timestamp tₖ, includes performing:
   (a) for the coarse grain data structure that is associated with the younger snapshotₖ: with respect to each entry that is representative of a write in a memory chunk, includes performing:
      1. with respect to each block of the chunk, test in at least one selected bloom filter of the at least one bloom filter if the corresponding group of bits is representative of a false positive, and provide “possible snapshots difference” indication.

In accordance with an embodiment of the presently disclosed subject matter, there is yet further provided a system, wherein (a) further includes: in case all the entries of the coarse grain data structure are representative of “no write” in the memory chunk, provide “no snapshots difference” indication.

In accordance with an embodiment of the presently disclosed subject matter, there is yet further provided a system, wherein each one of the at least one bloom filter is associated with a corresponding timestamp_{MIN} and timestamp_{MAX} and the bloom filter is selected if timestamp_{MIN}≤tₖ≤timestamp_{MAX}.

In accordance with an embodiment of the presently disclosed subject matter, there is yet further provided a system, wherein the possible snapshots difference indication includes performing: extract the older snapshotⱼ and the younger snapshotₖ and compare them to provide indication on whether they are identical or different.

In accordance with an embodiment of the presently disclosed subject matter, there is yet further provided a system for finding differences between two periodical snapshots, which further includes:
in response to a request to compare between two periodical snapshots in a series of snapshots extending over an oldest snapshot₁ and a youngest snapshot_{N} obtained at respective oldest timestamp t₁ and youngest timestamp t_{N}, perform comparison between the older snapshotⱼ and the younger snapshotₖ, where 1<k<N and j=k−1, wherein the coarse grain data structure that is associated with the younger snapshotₖ: has an entry that is representative of a write in a memory chunk, and the respective entry in the coarse grain data structure that is associated with each snapshotᵢ (where 1≤i≤k−1) is representative of a no write in the memory chunk.

In accordance with an aspect of the presently disclosed subject matter, there is yet further provided a system comprising:

a computerized device configured for finding differences between a given block in two periodical snapshots; the computerized device comprising at least one computer processor operatively connected to a computer data storage;

data indicative of a coarse grain data structure corresponding to the given logical unit and including a plurality of entries wherein each entry is representative of a write or no-write operation to a respective memory chunk of a first granularity in the logical unit; each memory chunk includes a plurality of blocks each of a second granularity that is considerably finer than the first granularity;

data indicative of at least one bloom filter, each bloom filter includes a plurality of bits wherein each group of bits is representative of a probable false positive write indication or no-write operation to a block in the chunk;

the data structure is further configured to store data including a plurality of periodic snapshotsᵢ and associated coarse grain data structure obtained at respective timestamp tᵢ;

the computer processor is configured to:
(a) in response to a request to compare between the given block in at least two periodic snapshots: an older snapshotⱼ and a younger snapshotₖ obtained at respective older timestamp tⱼ and younger timestamp tₖ, includes performing:
   1. with respect to the block in a chunk, test in at least one selected bloom filter of the at least one bloom filter if the corresponding group of bits is representative of a false positive, and provide “possible snapshots difference” indication.

In accordance with an embodiment of the presently disclosed subject matter, there is yet further provided a system, wherein the processor is configured to perform (a) with respect to each of at least one other block in the two periodic snapshots.

In accordance with an embodiment of the presently disclosed subject matter, there is yet further provided a system, wherein (a) further includes: in case the group of bits all are representative of “no write” in the block, provide “no block difference” indication.

In accordance with an embodiment of the presently disclosed subject matter, there is yet further provided a system, wherein each one of the at least one bloom filter is associated with a corresponding timestamp_{MIN} and timestamp_{MAX} and the bloom filter is selected if timestamp_{MIN}≤tₖ≤timestamp_{MAX}.

In accordance with an embodiment of the presently disclosed subject matter, there is yet further provided a system, wherein the possible snapshots difference indication includes performing: extract the older snapshotⱼ and a younger snapshotₖ and compare the block in the snapshots to provide indication on whether the block in the snapshots is identical or different.

In accordance with an aspect of the presently disclosed subject matter, there is yet further provided a system comprising:
a computerized device configured for finding differences between two periodical snapshots; the computerized device comprising at least one computer processor operatively connected to a computer data storage;
data indicative of a coarse grain data structure corresponding to the given logical unit and including a plurality of entries, wherein each entry is representative of a write or no-write operation to a respective memory chunk of a first granularity in the logical unit; each memory chunk includes a plurality of blocks each of a second granularity that is considerably finer than the first granularity;
data indicative of at least one bloom filter, each bloom filter including a plurality of bits wherein each group of bits is representative of a probable false positive write indication or no-write operation to a block in the chunk; wherein the memory space allocated to the coarse grain data structure and the bloom filter is significantly smaller than a memory space that would have been allocated to a reference coarse grain data structure, where each entry in the reference coarse grain data structure corresponds to a block in the logical unit;

the data structure is further configured to store data including a plurality of periodic snapshotsᵢ and associated coarse data structure obtained at respective timestamp tᵢ;

the computer processor is configured to:
(i) in response to a request to compare between at least two periodic snapshots: an older snapshotⱼ and a younger snapshotₖ obtained at respective older timestamp tⱼ and younger timestamp tₖ, includes performing:
   utilize the coarse data structure associated with the older snapshotⱼ and a younger snapshotₖ and an active bloom filter for determining the likelihood of difference between the older snapshotⱼ and younger snapshotₖ in a considerably more efficient computational complexity compared to tedious block-wise comparison between the older snapshotⱼ and a younger snapshotₖ

In accordance with an embodiment of the presently disclosed subject matter, there is yet further provided a system, wherein the computer processor is configured to determine an active bloom filter if the number of bits representative of a probable false positive write indication of a previous active bloom filter is larger than Z, where Z is calculated to guarantee error probability that is not less than a given value.

In accordance with an embodiment of the presently disclosed subject matter, there is yet further provided a system, wherein the given value is selected from a range of 15-30%.

In accordance with an aspect of the presently disclosed subject matter, there is yet further provided a method for finding differences between two periodical snapshots, by at least one computer processor operatively connected to a computer data storage, comprising:
(i) providing data indicative of a coarse grain data structure corresponding to a given logical unit and including a plurality of entries, wherein each entry is representative of a write or no-write operation to a respective memory chunk of a first granularity in the logical unit; each memory chunk includes a plurality of blocks each of a second granularity that is considerably finer than the first granularity;
(ii) providing data indicative of at least one bloom filter, each bloom filter including a plurality of bits, wherein each group of bits is representative of a probable false positive write indication or no-write operation to a block in the chunk; each bloom filter is associated with min timestamp and max timestamp;

the method further comprising:
(iii) in response to a write operation performed to a block in a memory chunk constituting a written block in a written memory chunk of a given logical unit,
   a. set in the coarse grain data structure that corresponds to the logical unit, the value of the entry that corresponds to the written memory chunk to be representative of a write operation; and
   b. set in an active bloom filter of the at least one bloom filter that corresponds to the logical unit, the value of the group of bits that corresponds to the written block being representative of a probable false positive write indication;

the method further comprising:
(iv) in response to obtaining a periodic snapshotᵢ of thelogical unit at a timestamp tᵢ:
   a. store at least the periodic snapshotᵢ, the data representative of the coarse grain data structure at the timestamp tᵢ and the timestamp tᵢ;
   thereby facilitating usage of the course grain data structure at the timestamp tᵢ and a bloom filter of the at least one bloom filter for determining differences between snapshots.

In accordance with an aspect of the presently disclosed subject matter, there is yet further provided a method for finding differences between two periodical snapshots, by at least one computer processor operatively connected to a computer data storage, comprising:
(I) providing data indicative of a coarse grain data structure corresponding to the given logical unit and including a plurality of entries wherein each entry is representative of a write or no-write operation to a respective memory chunk of a first granularity in the logical unit; each memory chunk includes a plurality of blocks each of a second granularity that is considerably finer than the first granularity;
(II) providing data indicative of at least one bloom filter, each bloom filter including a plurality of bits wherein each group of bits is representative of a probable false positive write indication or no-write operation to a block in the chunk;
(III) store data including a plurality of periodic snapshotsᵢ and associated coarse grain data structure obtained at respective timestamp tᵢ;

the method further comprising:
(IV) in response to a request to compare between at least two periodic snapshots: an older snapshotⱼ and a younger snapshotₖ obtained at respective older timestamp tⱼ and younger timestamp tₖ, includes performing:
   (a) for the coarse grain data structure that is associated with the younger snapshotₖ: with respect to each entry that is representative of a write in a memory chunk, includes performing:
      (i) with respect to each block of the chunk, test in at least one selected bloom filter of the at least one bloom filter if the corresponding group of bits is representative of a false positive, and provide “possible snapshots difference” indication.

In accordance with an aspect of the presently disclosed subject matter, there is yet further provided a method for finding differences between a given block in two periodical snapshots, by at least one computer processor operatively connected to a computer data storage, comprising:
(I) providing data indicative of a coarse grain data structure corresponding to the given logical unit and including a plurality of entries wherein each entry is representative of a write or no-write operation to a respective memory chunk of a first granularity in the logical unit; each memory chunk includes a plurality of blocks each of a second granularity that is considerably finer than the first granularity;
(II) providing data indicative of at least one bloom filter, each bloom filter includes a plurality of bits wherein each group of bits is representative of a probable false positive write indication or no-write operation to a block in the chunk;
(III) store data including a plurality of periodic snapshotsᵢ and associated coarse grain data structure obtained at respective timestamp tᵢ;

the method further comprising:
(IV) in response to a request to compare between the given block in at least two periodic snapshots: an older snapshotⱼ and a younger snapshotₖ obtained at respective older timestamp tⱼ and younger timestamp tₖ, includes performing:
   1. with respect to the block in a chunk, test in at least one selected bloom filter of the at least one bloom filter if the corresponding group of bits is representative of a false positive, and provide “possible snapshots difference” indication.

In accordance with an aspect of the presently disclosed subject matter, there is yet further provided a method for finding differences between two periodical snapshots, by at least one computer processor operatively connected to a computer data storage, comprising:
(i) data indicative of a coarse grain data structure corresponding to the given logical unit and including a plurality of entries, wherein each entry is representative of a write or no-write operation to a respective memory chunk of a first granularity in the logical unit; each memory chunk includes a plurality of blocks each of a second granularity that is considerably finer than the first granularity;
(ii) providing data indicative of at least one bloom filter, each bloom filter including a plurality of bits wherein each group of bits is representative of a probable false positive write indication or no-write operation to a block in the chunk; wherein the memory space allocated to the coarse grain data structure and the bloom filter is significantly smaller than a memory space that would have been allocated to a reference coarse grain data structure, where each entry in the reference coarse grain data structure corresponds to a block in the logical unit;
(iii) store data including a plurality of periodic snapshotsᵢ and associated coarse data structure obtained at respective timestamp tᵢ;

the method further comprising:
(iv) in response to a request to compare between at least two periodic snapshots: an older snapshotⱼ and a younger snapshotₖ obtained at respective older timestamp tⱼ and younger timestamp tₖ, includes performing:
   utilize the coarse data structure associated with the older snapshotⱼ and a younger snapshotₖ and an active bloom filter for determining the likelihood of difference between the older snapshotⱼ and younger snapshotₖ in a considerably more efficient computational complexity compared to tedious block-wise comparison between the older snapshotⱼ and a younger snapshotₖ.

In accordance with an embodiment of the presently disclosed subject matter, there is yet further provided a machine-readable non-transitory memory tangibly embodying a program of instructions executable by a processor for executing the proposed method.

In accordance with an embodiment of the presently disclosed subject matter, there is yet further provided a machine-readable non-transitory memory tangibly embodying a program of instructions executable by a processor for executing the proposed method.

In accordance with an embodiment of the presently disclosed subject matter, there is yet further provided a machine-readable non-transitory memory tangibly embodying a program of instructions executable by a processor for executing the proposed method.

In accordance with an embodiment of the presently disclosed subject matter, there is yet further provided a machine-readable non-transitory memory tangibly embodying a program of instructions executable by a processor for executing the proposed method.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1A is a schematic block-diagram illustration of a computer storage system according to examples of the presently disclosed subject matter;

FIG. 1B is a schematic block-diagram illustration of a control unit according to examples of the presently disclosed subject matter;

FIGS. 2A-B shows a data structure that includes a plurality of coarse grain bitmap and bloom filter data structures, in accordance with an example of the presently disclosed subject matter;

FIGS. 3A-B are flowcharts showing examples of a sequence of operations related to write data operation, in accordance with an example of the presently disclosed subject matter;

FIG. 4 is a flowchart showing an example of a sequence of operations related to find differences between snapshots, in accordance with an example of the presently disclosed subject matter; and

FIG. 5 is a flowchart showing an example of a sequence of operations related to find differences between snapshots, in accordance with an example of the presently disclosed subject matter.

### DETAILED DESCRIPTION

Unless specifically stated otherwise, as apparent from the following discussions, it is appreciated that throughout the specification discussions utilizing terms such as “receiving”, “executing”, “reading”, “persisting”, “writing”, “designating”, “determining”, “performing”, “corresponding”, “comparing” or the like, include actions and/or processes of a computer that manipulate and/or transform data into other data, said data represented as physical quantities, e.g. such as electronic quantities, and/or said data representing the physical objects.

The terms “computer”, “computer device”, “control unit”, “server” or the like as disclosed herein should be broadly construed to include any kind of electronic device with data processing circuitry, which includes a computer processing device configured to and operable to execute computer instructions stored, for example, on a computer memory being operatively connected thereto. Examples of such a device include: a digital signal processor (DSP), a microcontroller, a field programmable gate array (FPGA), an application specific integrated circuit (ASIC), a laptop computer, a personal computer, a smartphone, etc.

As used herein, the phrase “for example,” “such as”, “for instance” and variants thereof describe non-limiting embodiments of the presently disclosed subject matter. Reference in the specification to “one case”, “some cases”, “other cases”, “one embodiment”, “certain embodiments” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

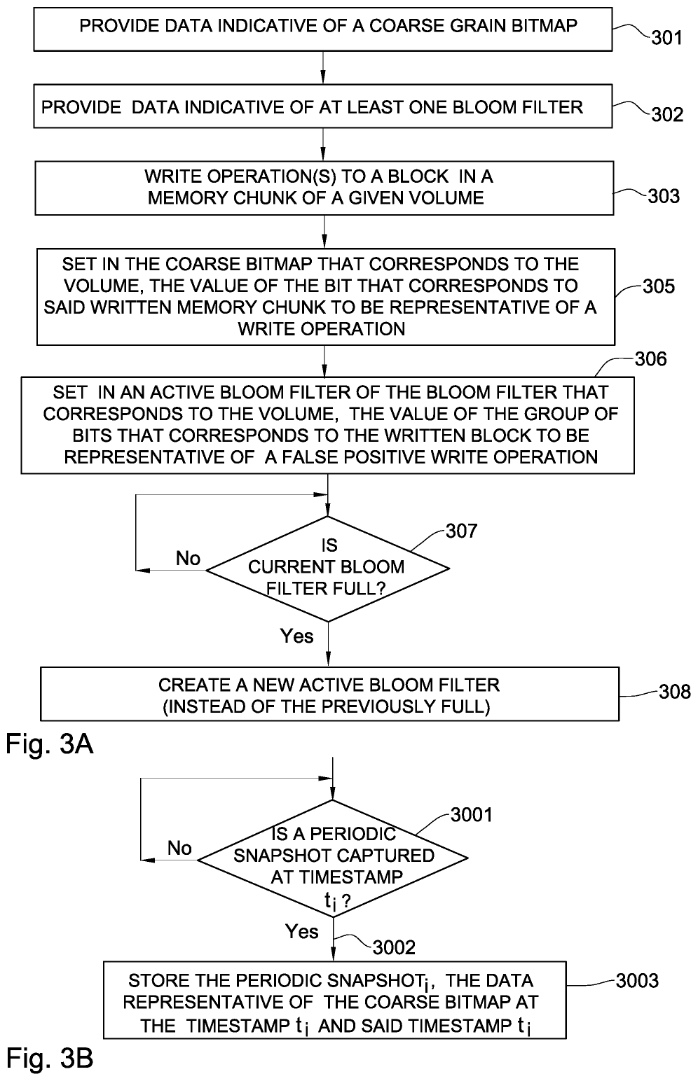

In embodiments of the presently disclosed subject matter, fewer, more and/or different stages than those shown in any of FIGS. 3 to 5 may be executed. In embodiments of the presently disclosed subject matter, one or more stages illustrated in any of FIGS. 3 to 5 may be executed in a different order and/or one or more groups of stages may be executed simultaneously.

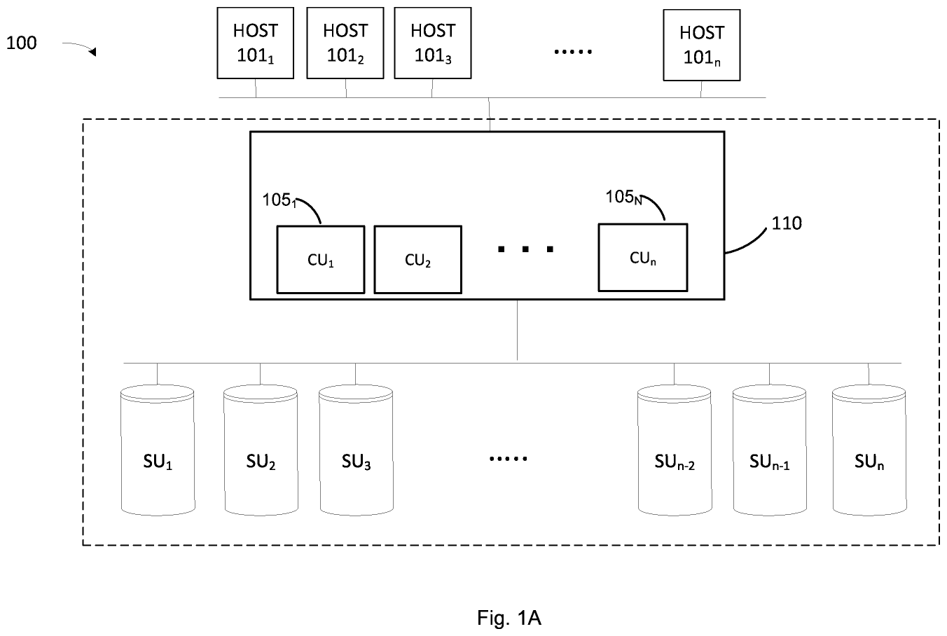

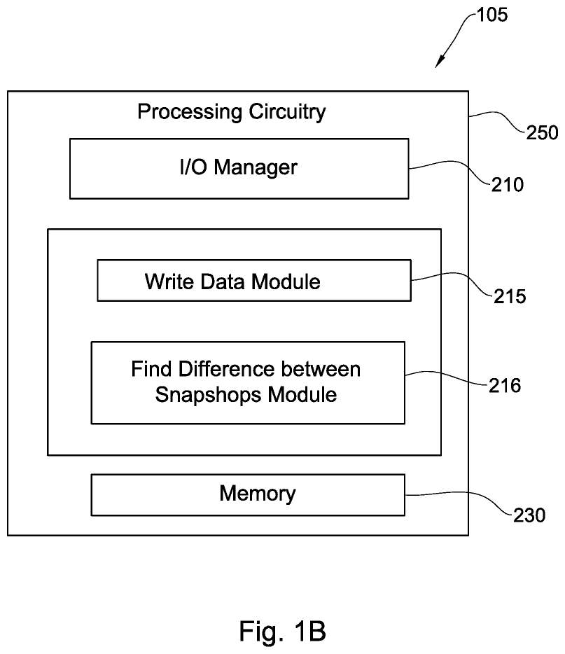

FIG. 1A to FIG. 1B illustrate various aspects of the system architecture in accordance with some examples of the presently disclosed subject matter. Elements in FIG. 1A to FIG. 1B can be made up of a combination of software and hardware and/or firmware that performs the functions as defined and explained herein. Elements in FIG. 1A to FIG. 1B may be centralized in one location or dispersed over more than one location. In other examples of the presently disclosed subject matter, the system may comprise fewer, more, and/or different elements than those shown in FIG. 1A to FIG. 1B. For example, some components of control unit 105 can be implemented as a separate unit in interface layer 110 or implemented on an external server or be otherwise operatively connected to the storage system for enabling management of I/O operations.

Note that for convenience of explanation the description below refers to “volume”. Note, however, that the invention may apply to other logical unit mutatis mutandis, not necessarily in a volume boundary.

Note also that for convenience of explanation the description below refers to “a coarse grain bitmap”. Note, however, that the invention may apply to other coarse grain data structure mutatis mutandis, not necessarily to a bitmap.

Note also that for convenience of explanation the description below refers to “bit(s)” in the coarse grain bitmap data structure. Note, however, that the invention may apply to other “entries” in the coarse grain bit map mutatis mutandis, not necessarily in a bit boundary.

Bearing the above in mind, attention is drawn to FIG. 1A, which is a schematic block-diagram of a computer storage system, according to some examples of the presently disclosed subject matter. Storage system 100 includes a physical storage space comprising one or more physical storage units (SU₁₋ₙ) also known as enclosures, each physical storage unit comprising one or more storage devices. Storage devices (referred to herein below also as “disks”) may be any one of Hard Storage devices (HDD) or Solid State Drives (SSD, comprising for example, a plurality of NAND elements), DRAM, non-volatile RAM, or any other computer storage device or combination thereof. Physical storage units (SU₁₋ₙ) can be consolidated in a single unit, or can be otherwise distributed over one or more computer nodes connected by a computer network.

Storage system 100 can further comprise an interface layer 110 comprising various control units (CU 105₁₋ₙ) operatively connected to the physical storage space and to one or more hosts (101₁₋ₙ), and configured to control and execute various operations in the storage system. For example, control units 105₁₋ₙ can be adapted to read data and/or metadata from the storage (SU₁₋ₙ), and/or write data and/or metadata to the storage (SU₁₋ₙ). Various other examples of operations performed by the control units are described in more detail below. Control units 105₁₋ₙ can be adapted to execute operations responsive to commands received from hosts 101₁₋ₙ. A host includes any computer device which communicates with interface layer 110 e.g. a PC computer, working station, a Smartphone, cloud host (where at least part of the processing is executed by remote computing services accessible via the cloud), or the like.

According to some examples, the presently disclosed subject matter contemplates a distributed storage system with an interface layer 110 configured with multiple interconnected control units 105₁₋ₙ. As would be apparent to any person skilled in the art, unless stated otherwise, principles described herein with respect to a single control unit can be likewise applied to two or more control units in system 100.

According to some examples, different control units 105₁₋ₙ in the interface layer 110 (where a control unit is implemented, in some examples, by a dedicated computer device, e.g., a dedicated computer server device) can be assigned for managing and executing operations related to a certain area within the physical storage space (e.g. an area comprising, for example, one or more designated physical storage units or parts thereof). In some examples, there are at least two control units that are each assigned to control operations (e.g. handle I/O requests) at respective non-overlapping storage areas, such that one control unit cannot access the storage area assigned to the other control unit, and vice versa.

By way of example, control units can hold translation tables or implement translation functions which map logical addresses to the respective physical storage space in order to assign a read or write command to the one or more control units responsible for it. In response to receiving an I/O request, the control unit that received the request can be configured to determine with which address (defined for example by a logical unit and logical block address—LU,LBA) the I/O request is associated. The control unit can use the address mapping tables (or mapping functions) to determine, based on the logical address referenced in the I/O request, to which storage location in the physical storage to address the I/O request, and which control unit is responsible for processing this request.

In some examples (e.g. for the purpose of redundancy and/or efficiency) two or more control units can be assigned to handle I/O requests addressing the same physical storage area. According to this approach, communication between different components in computer system 100 can be realized over a network (e.g. Ethernet) where different control units communicate for the purpose of synchronizing execution of operations e.g. in order to increase efficiency and reduce processing time. In some examples, two control units are each assigned to control operations at non-overlapping storage areas and also at a different overlapping storage area.

Communication between hosts (101₁₋ₙ) and interface layer 110, between interface layer 110 and storage units (SU₁₋ₙ) and within interface layer 110 (e.g., between different control unit 105₁₋ₙ) can be realized by any suitable infrastructure and protocol. Hosts (101₁₋ₙ) can be connected to the interface layer 110 directly or through a network (e.g. over the Internet). According to one example, communication between various elements of storage system 100 is implemented with a combination of Fiber Channel (e.g. between hosts and interface layer 110), SCSI (e.g. between interface 110 and storage units) and InfiniBand (e.g. interconnecting different control units in interface 110) communication protocols. According to other examples, communication between various elements of storage system 100 is implemented while making use of Non-Volatile Memory Express (NVMe), also known as Non-Volatile Memory Host Controller Interface Specification (NVMHCIS) or NVMe over Fabric.

FIG. 1B is a schematic block-diagram showing some components of a control unit according to some examples of the presently disclosed subject matter. It is noted that FIG. 1B is provided for illustrative purposes only and should not be construed as limiting; in reality a control unit includes additional elements and/or different designs.

Control unit 105 can be implemented on a computer device comprising a processing circuitry 250. The processing circuitry 250 is configured to provide processing capability necessary for the control unit to function as further detailed below with reference to FIGS. 3 to 5. Processing circuitry 250 comprises or is otherwise operatively connected to one or more computer processors (not shown separately) and memory. According to some examples, the processor(s) of processing circuitry 250 can be configured to execute one or more functional modules in accordance with computer-readable instructions implemented on a non-transitory computer-readable memory of the processing circuitry. Such functional module(s) are referred to hereinafter as comprised in the processing circuitry (for instance “write data” module 215 and “find difference between snapshots” module 216, all as will be described in greater detail below).

Processing circuitry 250 can comprise, by way of example, an I/O manager 210 configured to handle I/O requests, received for example from host computers 101₁₋ₙ. I/O manager 210 can comprise or be otherwise operatively connected to a data-storage unit (comprising computer storage as detailed above) configured to store data and/or metadata, configurations and/or logic which are used by I/O manager 210.

According to further examples, processing circuitry 250 of control unit 105 can further comprise, or be otherwise operatively connected to, memory 230.

Memory 230 can be utilized for storing information needed for mapping between the physical storage space and the respective logical representation as mentioned above. Memory 230 can be utilized for example for storing data used for processing by processing circuitry 250 and serve as a source or destination of pertinent data to and from storage device(s).

Having provided a high level description of the various components of the storage system, more details are now provided with respect to operation of the storage system.

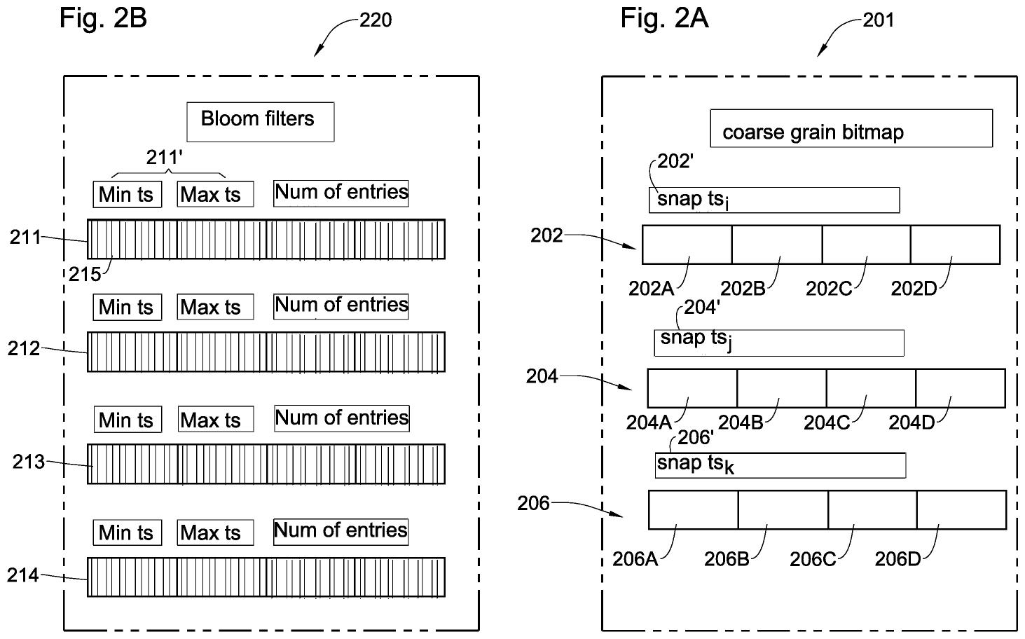

Attention is now drawn to FIGS. 2A-B showing a data structure that includes a plurality of coarse bitmap and bloom filter data structures, in accordance with an example of the presently disclosed subject matter. Note that the data structure may be stored in the storage system (e.g. one or more of the storage devices discussed above). Note also that the invention is not bound by any specific data structure or data structures, and the exemplary data structures illustrated in FIGS. 2A and B are provided for illustrative purposes only.

As shown in FIG. 2A, the data structure 201 may include data indicative of a coarse bitmap 202 corresponding to a given volume (e.g. in the specified storage device) and include a plurality of bits (by this example 4 bits (designated by this example 202_{A} to 202_{D}, respectively) wherein each bit is representative of a “write” or “no-write” operation to a respective memory chunk of a first granularity in said volume. Consider by way of non-limiting example that the volume size is 8 Mbyte, then the first bit 202_{A} (out of four) may be set to “1” (or in another embodiment reset to 0) in case a “write operation” is performed to a block or blocks of the first memory chunk of the volume. The specified first granularity is thus by this example 2 Mbyte, wherein the first bit represents the first 2Mbytes of the volume. The second bit 202_{B} represents the next 2M of the volume and so forth.

Each memory chunk includes a plurality of blocks, each of a second granularity that is considerably finer than said first granularity. Thus, by way of non-limiting example, each block size may be 4K.

As shown in FIG. 2B, data structure 220 includes data indicative of plurality of known per se bloom filters. Each bloom filter (by this example 211 to 214) includes a plurality of bits wherein each group of bits (by one example a group may include a single bit, 2 bits, or 3 bits, depending upon the particular application) that when set may be representative of a “probable false positive write indication” (namely a certain probability that write has been made to a block or blocks in a chunk that correspond(s) to the specified group of bits in the bloom filter) or “no-write” operation to a block(s) in the chunk. A block size may be for example of size 4K. Each bloom filter is associated with parameters such as “min timestamp” (namely the oldest time at which data was written to the bloom filter), “max timestamp” (namely the latest time at which data was written to the bloom filter) and “Number of entries”, namely bits that are included in the bloom filter. Note that the invention is not bound by the specified parameters.

The term bloom filter should be construed to include: a space-efficient probabilistic data structure, that is used to test whether an element is a member of a set. False positive matches are possible, but false negatives are not—in other words, a query returns either “possibly in set” or “definitely not in set”. The more elements that are added to the set, the larger the probability of false positives. The invention is not bound by this exemplary definition.

In accordance with certain embodiments, each write will be stored in an active bloom filter. By one example, if the size of the number of entries (e.g. bits) is larger than Z, then the next bloom filter (from the available bloom filters) will be marked as active. Z may be calculated such that the error probability (namely the false positive probability), is not high. For example, lower than 20% (or any other value) may be determined, depending upon the particular application. Intuitively, an active bloom filter ceases to be active if the probability of false positive write indications gets overly high.

In accordance with certain embodiments, the number of the bloom filters (in the example of FIG. 2B-4 filters) may be defined such that it is a function of single bloom filter size, update block rate,

In addition, in accordance with certain embodiments, for each periodic snapshotᵢ captured at a timestamp tᵢ, the periodic snapshotᵢ is stored (e.g. at the specified storage device(s)) as well as data representative of at least the coarse bitmap at said timestamp tᵢ and the timestamp tᵢ. This, as will be explained in further detail below, will facilitate determination of differences between snapshots.

Reverting again to FIG. 2A, consider, say, three snapshots (i, j and k captures at respective timestamps tᵢ, tⱼ, and tₖ). In addition to storing the snapshots, the respective coarse bitmap “snapshot” at the specified timestamps are also stored (e.g. in the specified storage device(s)). The exemplary coarse bitmap snapshots for the specific time stamps are shown and indicated as 202, 204 and 206 (with their respective stored timestamps tᵢ, tⱼ, and tₖ (designated 202′, 204′ and 206′ respectively). The invention is not bound by the number of snapshots, the pertinent data structures for storing the specified data, as well as by the data stored. For instance, more parameters may be stored with respect to each snapshot.

Before moving on to describe the sequence of operations with reference to FIGS. 3 to 5, it should be noted that they can be executed, for example, by one or more control units 105 described above. It should be appreciated, that while some operations are described with reference to components of system 100 and its components presented above, this is done by way of example only, and this should not be construed to limit the operations to being implemented on such components alone.

As described above, the storage system (also referred to herein as a distributed data-storage system) described herein comprises multiple control units (also referred to herein as computer devices). The multiple computer devices can be operatively connected to a shared physical storage space of the storage system which is operable by the multiple computer devices. The shared physical storage space can comprise one or more storage devices. Each computer device can be assigned with write access to a respective physical storage area in the storage system.

Bearing this in mind, attention is now drawn to FIG. 3A illustrating a flowchart showing an example of a sequence of operations related to a write data operation, in accordance with an example of the presently disclosed subject matter, and occasionally also to FIGS. 2A-B showing a functional block diagram of a data structure that includes data indicative of a plurality of coarse bitmap and bloom filter instances, in accordance with an example of the presently disclosed subject matter. Note that the specified sequence of operations may be executed on “write data module” 216 that may run on processing circuitry 215. The invention is not bound by this specific implementation.

Thus, in response to a write operation performed to a block in a memory chunk ((303 and 304)—constituting a written block in a written memory chunk of a given volume), set in the coarse bitmap that corresponds to the volume, the value of the bit that corresponds to the written memory chunk to be representative of a write operation 305. For instance, consider for a volume of 8 Mbyte and a coarse bit map data structure that includes 4 bits each representative of 2Mbytes memory chunk, then if a write operation is performed to a block (of say of 4 Kbyte size) in the address of “xxx” (i.e. the second block of the first chunk in the volume), then (in step 305) the first bit (out of four) of the coarse bit map data structure (say 202) is set to “1” (assuming that they are all pre-set to “0”). Obviously, the other way around can also hold true namely that all the bits are a priori set to “1” and hence the first bit will be set to “0” indicating that the write operation has been done to the specified memory chunk in a given volume.

Note that whilst in the examples herein a bitmap is assigned per volume in accordance with certain other embodiments, a bit map may apply to any other logical unit not necessarily in volume boundary. The invention is not bound by the latter example and other arrangements may apply depending upon the particular application.

Consider also that the active bloom filter (in the manner discussed above) is 211. Then, in step (306), the value of the group of bits that corresponds to said written block is set to be representative of a “probable false positive write operation indication” (e.g. when the group of bits is set to “1”). The false positive nature of the bloom filter means that probably a write operation has occurred. Thus, for example, consider that writes had set all the bits in the bloom filter, from now on each query of the bloom filter will return that a write occurred because of the false positive indication characteristic.
The utilization of this “probable write” characteristic will be explained in greater detail below when referring to test differences between snapshots operation.

A non-limiting example of determining the specified group of bits to be set in the bloom filter is as follows: calculating a group of key values as corresponding functions of at least a Volume_Id (of the given volume), Address of the given block and last_snapshot_timestamp. The key values is used to determine the address of the resulting group of bits (say, utilizing a group of corresponding hash functions of the specified keys which in turn correspond to the group of bits) and the values of the group of bits is set to “1”.

Turning to step 307, in case that the current “active” Bloom filter is full (as will be explained in greater detail below) then (308) another bloom filter is created and becomes an “active” Bloom filter instead of the previously full Bloom filter.

In accordance with certain embodiments, an active bloom filter may be determined based on said number of bits representative of false positive write indication. More specifically, an active bloom filter is determined if the number of bits representative of of a probable false positive write indication in a previous active bloom filter is larger than Z, where Z is calculated to guarantee error probability that is not less than a given value.

The given value may be selected from a range of 15-30%. This range is of course not binding and may vary depending upon the particular application.

Turning now to FIG. 3B, in response to obtaining a periodic snapshotᵢ of the volume at a timestamp tᵢ (3001, 3002), store (3003) (say in one of the specified storage devices) the periodic snapshotᵢ, and data representative of the coarse bitmap at the timestamp tᵢ and said timestamp tᵢ (for example 202 and 202′).

As will be explained in greater detail below, this will facilitate determination of differences between snapshots.

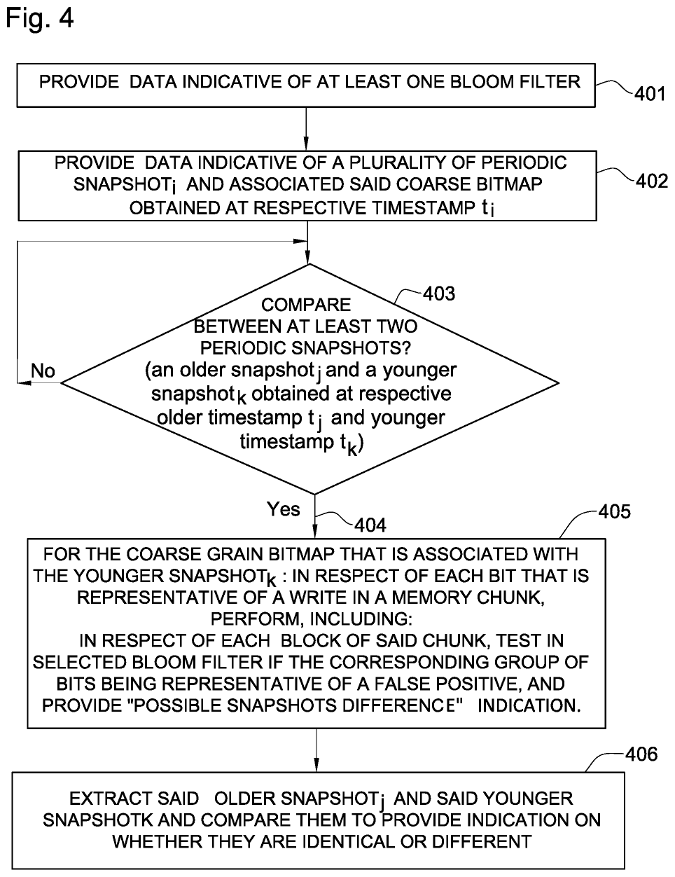

Having described a non-limiting example of a write data sequence of operations, attention is now drawn to FIG. 4 illustrating a flowchart of an exemplary sequence of operations related to find differences between snapshots, in accordance with an example of the presently disclosed subject matter. Note that the specified sequence of operations may be executed on “find difference between snapshots” module 217 that may run on processing circuitry 215. The invention is not bound by this specific implementation.

Thus, in response to a request/command to compare between two periodic snapshots: say older snapshotⱼ and a younger snapshotₖ (obtained at respective older timestamp tⱼ and younger timestamp tₖ), perform (403, 404) including:

for the coarse bitmap that is associated with the younger snapshotₖ: with respect to each bit that is representative of a “write in a memory chunk”, includes performing:

with respect to each block of said chunk, test in selected bloom filter of said at least one bloom filter if the corresponding group of bits is representative of a probable false positive write indication, and provide “possible snapshots difference” indication (405).

In accordance with certain embodiments, and as arises from step 406, in case of possible snapshots difference indication, perform: extract said older snapshotⱼ and said younger snapshotₖ and compare them to provide indication on whether they are identical or different. In accordance with certain other embodiments, the need to read and compare the data in its entirety may be obviated, e.g. storing Meta Data (MD) for each write, and retrieving only the MD (all as known per se).

More specifically, and by way of example, consider the exemplary series of three snapshots (of a given volume—not shown) captured at respective timestamps tᵢ, tⱼ and tₖ. Their corresponding data indicative of coarse grain bitmaps (see 202, 204 and 206) are also captured and stored (e.g. in storage device(s) all as described above with reference to FIG. 1A).

Consider a command to compare differences between two snapshots (a command/request may be explicit or implicit), say snapshotᵢ and snapshotⱼ (captured at tᵢ, tⱼ respectively), where snapshotᵢ stands for the older snapshot and snapshotⱼ, captured at a later stage, stands for the younger snapshot.

As explained with reference to step 404, the coarse bitmap structure that is associated with the younger snapshot (by this example 204), is tested. As may be recalled by way of non-limiting example, each of the bits 204_{A} to 204_{D} represents a memory chunk of 2Mbytes in the volume. Thus, the first bit (204_{A}) is tested to check if it is representative of a “write operation” to the first memory chunk. Assuming that value “0” represents “no-write” and value “1” represents “write”. Thus, in case the latter bit value is “0”, this indicates that “no write” has occurred to the first memory chunk until (the younger) timestamp tⱼ. has been captured. Obviously, if by any later time no write has occurred, it readily arises that also by tᵢ (the timestamp that the older snapshot was captured), no write has occurred to this memory chunk. Otherwise, had such write been made by the time that the older snapshot was taken, this “write” would have been reflected in the corresponding bit of the bitmap instance that was captured together with snapshotᵢ (the older) and would have been reflected also in the corresponding bit of the bitmap instance that was captured together with the younger snapshotⱼ. Thus, it is sufficient to test the value of the corresponding bit in the coarse bitmap instance of the younger snapshot, and in case it represents “no write” (by this example value “0”) this indicates that the specified memory chunk (by this example the first 2Mbytes of the given volume) has not been written and therefore no change has occurred between the memory chunks of the respective snapshots (by this example snapshotᵢ and snapshotⱼ). Note that the latter test is very efficient in terms of computation complexity, as one bit test provides indication for the entire 2Mbytes memory, obviating the need for tedious comparison between the actual memory chunk data in the two snapshots.

Note that additional tests may be performed, e.g. testing also the bits of the older snapshots and/or others.

In case the other bits of the coarse bitmap instance associated with the younger snapshot (by this example also bits 204_{B} to 204_{D}) all represent a no-write operation, this indicates that there is no difference between the snapshots (I and j), while running a very cheap test (in computational complexity terms) namely by this example testing (4 bits).

Turning to the other scenario, i.e. at least one of the bits of the coarse bitmap instance (by this example any of the bits 204_{A} to 204_{D}) represents a “write operation” (by this example set to “1”). Thus, as explained with reference to step 405, a selected bloom filter data structure is utilized. (The latter may also be stored in one of more of the storage devices, all as discussed above).

As may be recalled, each bloom filter may be associated with a corresponding “timestamp_{MIN}” (namely the oldest time at which data was written to the bloom filter), “timestamp_{MAx}” (namely the latest time at which data was written to the bloom filter).—see for example 211′ of bloom filter 211. In accordance with certain embodiments, the specified selected bloom filter is the one where the timestamp tⱼ associated with the younger snapshotⱼ complies with the following: timestamp_{MIN}≤tⱼ≤timestamp_{MAX}. Consider, for example, that the selected bloom filter instance is 211.

As may be further recalled, each bloom filter may include a plurality of bits wherein each group of bits (1 or more bits) is representative of a “probable false positive write indication” or “no-write” operation to a block in said chunk. Still further, the bloom filter is representative of a plurality of blocks (in the specified volume) wherein each block is of a second granularity that is considerably finer than the first granularity (of the memory chunk). Reverting to the example above, the size of each block may be of 4 Kbyte (compared to a memory chunk size of, say 2 Mbyte).

Thus, in step 405 with respect to each block of said chunk, test in the selected bloom filter (e.g. 211) if the corresponding group of bits is representative of a “probable false positive write indication”, and provide “possible snapshots difference” indication (405).

More specifically, in accordance with certain embodiments, in order to test if a group of bits is representative of a probable false positive write indication for a given block, a group of key values may be calculated as functions of, say (at least_a Volume_Id of said given volume, Address of said given block and snapshot_timestamp (in the latter example tⱼ). The key values may be used to determine the address of the resulting group of bits (say, utilizing a corresponding groups of hash functions each applied to a respective key of the group) and the values of the group of bits are extracted. As specified above, the group of bits may be one or more bits. If all of the bits in the group indicate “no-write” (say value “0”), this is a clear indication that the specified block has not been written by the time that the younger snapshotⱼ has been captured, and consequently the need to test the same block in the other (older) snapshot may be obviated.

This test is repeated for all the blocks in the memory chunk.

In accordance with certain embodiments, there may be a need to test multiple bloom filters according the to min tₛ and max tₛ thereof. depending if the active bloom filter was full or not.

For any block whose corresponding bits in the group have a value representative of a probable false positive write indication (in response to the specified test), this is an indication that there are certain prospects that the specified block has been written before the snapshotⱼ has been captured. Since, however, the inherent characteristics of the bloom filter entail that this is only a “false positive” indication, there is a need to actually check if there is a difference between the block data in the specified snapshots (I and j). To this end, the data of the block is extracted from the snapshots (i and j) and compared—i.e. the block in snapshotᵢ is compared to the corresponding block in snapshotⱼ, in order to determine unequivocally whether the block data is different or identical.

This procedure is performed for each block that resulted in a false positive right indication as a result of the specified test.

Note that in case of n>1 blocks which resulted in a “false positive write indication” indication as a result of the specified test, the number of accesses m to the storage device(s) to extract the block data may be m<n for improving system performance.

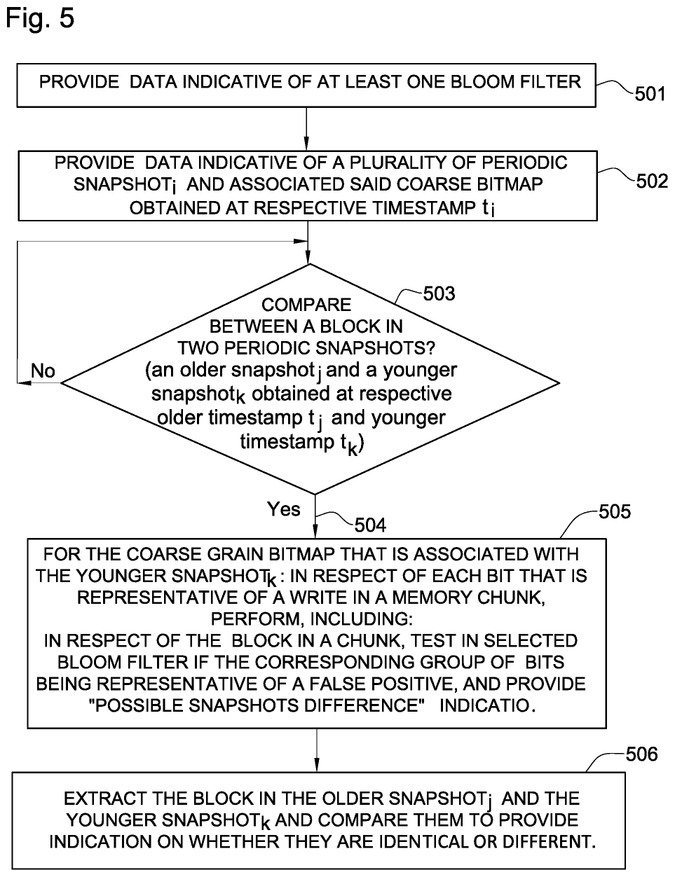

In accordance with certain embodiments, where the request (request includes explicit or implicit command) is not to determine differences between snapshots, but rather if a given block (or specified blocks) has (have) been changed in two snapshots, the sequence of operations discussed with reference to FIG. 4, may be applied to only the given block or specified blocks (whichever the case may be), whilst the need to examine the other blocks is obviated. This process is illustrated in FIG. 5. mutatis mutandis.

In accordance with certain embodiments, there is a need to check if there is a difference between any of a series of snapshot₁ to snapshot_{N} taken over a time period t₁ to t_{N}.

Thus, in response to a request/command to compare between two periodical snapshots in a series of snapshots extending over an oldest snapshot₁ and a youngest snapshot_{N} obtained at respective oldest timestamp t₁ and youngest timestamp t_{N}, perform comparison between said older snapshotⱼ and said younger snapshotₖ, where 1<k<N and j=k−1, wherein the coarse grain bitmap that is associated with the younger snapshotₖ: has a bit that is representative of a “write” to a memory chunk and the respective bit in the coarse grain bitmap that is associated with each snapshotᵢ (where 1≤i≤k−1) is representative of “no write” to said memory chunk.

Thus, by way of example, consider the snapshots i, j and k (and their respective coarse bitmap instants 202, 204 and 206). For finding differences between the snapshots, a scan is performed to identify a younger snapshot with a bit representative of a “write operation” to a memory chunk, provided that all the older snapshots in the series have each a corresponding bit that is set to “no write”. For a better understanding, and with reference to example of FIG. 2A, assuming that the bit 206_{A} of snapshotₖ (constituting the younger snapshot) is representative of a “write operation” (e.g. set to “1”) whereas the respective bits 204_{A} and 202_{A} of all the older snapshots (by this example snapshotᵢ and snapshotⱼ) are representative to “no-write operation” (i.e. “0”), this means that there is a need to check if any write has occurred between snapshotⱼ and snapshotₖ (because of the change to “1” between bits 204_{A} and 206_{A}). In response to the latter, a find difference between two snapshots sequence operations will be invoked (between snapshotⱼ and snapshotₖ), e.g. in accordance with the sequence of operations described in detail with reference to FIG. 4.

Note that if all of the bits that correspond to the first memory chunk (by this example 202_{A}, 204_{A} and 206_{A}) are set to “0” (i.e. no write has occurred to the first chunk) then a similar procedure will be performed with respect to the next set of bits (202_{B}, 204_{B} and 206_{B} corresponding to the second chunk) and so forth until a change has been encountered, or all the memory chunks have been checked in the manner specified.

Note that additional tests may be performed, e.g. testing also the selected bloom filter that corresponds to the older snapshot.

Note also that the specified sequence of operations with reference to find difference in a block or specified blocks in two snapshots, or find difference between snapshots in a series of snapshots, may be executed on “find difference between snapshots” module 217 discussed above, or in accordance with certain embodiments in other modules, whichever the case may be. The invention is not bound by this specific implementation.

Note that while for convenience of explanation the examples above assumed that the memory space is of volume boundary (of an exemplary 8 Mbyte size) with 4 memory chunks of 2Mbytes each and a plurality of blocks (of an exemplary 4 Kbyte each), the invention is by no means bound to volume or sub-volume boundary, and any other storage space may apply and likewise the specified numerical values are given for illustrative purposes only and are by no means binding.

Note that throughout the description the term “volume” is provided by way of example as a memory space that includes a plurality of memory chunks, and accordingly other memory space units may apply e.g. partial volume, plurality of volumes and so forth (not necessarily in volume boundaries).

In accordance with various embodiments of the presently disclosed subject matter at least the following advantages are obtained:
1. Small memory space, i.e. “small coarse bit map” data—considering the coarse granularity thereof and a finer set of bloom filters which, whilst representing blocks of finer granularity, are still efficient in terms of space, compared for example to a bit map holding a fine representation of the blocks, as is the case in the prior art. Thus, for example, the memory space allocated to the coarse grain bit map and said bloom filter, in accordance with certain embodiments of the invention, is significantly smaller than a memory space that would have been allocated to a reference coarse grain data structure, where each entry in said reference coarse grain data structure corresponds to a block in said logical unit.
2. High performance: most of the computational tasks are performed without extracting large chunks of data from the storage devices (e.g. snapshots or portions thereof) but rather check the data structures (and more specifically the data indicative of the bloom filter and coarse bitmap which is considerably more efficient in terms of computational complexity). The proposed technique discussed above with reference to various embodiments of the invention, is considerably more efficient computational complexity compared to, say tedious block-wise comparison between said older snapshotⱼ and a younger snapshotₖ.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a computer-readable non-transitory memory tangibly embodying a program of instructions executable by the computer for performing the method of the presently disclosed subject matter. The term “non-transitory” is used herein to exclude transitory, propagating signals, but to otherwise include any volatile or non-volatile computer memory technology suitable to the application.

It is also to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A system comprising:
a computerized device configured for finding differences between two periodical snapshots; the computerized device comprising at least one computer processor operatively connected to a computer data storage;
data indicative of a coarse grain data structure corresponding to a given logical unit and including a plurality of entries, wherein each entry is representative of a write or no-write operation to a respective memory chunk of a first granularity in said logical unit; each memory chunk includes a plurality of blocks each of a second granularity that is considerably finer than said first granularity;
data indicative of at least one bloom filter, each bloom filter including a plurality of bits, wherein each group of bits is representative of a probable false positive write indication or no-write operation to a block in said chunk; each bloom filter is associated with min timestamp and max timestamp;
the computer processor is configured to:
in response to a write operation performed to a block in a memory chunk constituting a written block in a written memory chunk of a given logical unit,
(iv) set in the coarse grain data structure that corresponds to said logical unit, the value of the entry that corresponds to said written memory chunk to be representative of a write operation; and
(v) set in an active bloom filter of said at least one bloom filter that corresponds to said logical unit, the value of the group of bits that corresponds to said written block being representative of a probable false positive write indication;
the computer system is further configured to, in response to obtaining a periodic snapshotᵢ of said logical unit at a timestamp tᵢ
(vi) store at least the periodic snapshotᵢ, said data representative of the coarse grain data structure at said timestamp tᵢ and said timestamp tᵢ;
thereby facilitating usage of said course grain data structure at said timestamp tᵢ and a bloom filter of said at least one bloom filter for determining differences between snapshots.

2. The system of claim 1, wherein said computer processor is configured to set in said active bloom filter the value of the group of bits, including
a. calculating a group of key values as corresponding functions of at least a Volume_Id of said given logical unit, address of said given block and last_snapshot_timestamp; and
b. set in said active bloom filter the value of the group of bits according to said keys.

3. The system of claim 1, wherein said group of bits includes any of 1 to 3 bits.

4. The system according to claim 1, wherein the bloom filter is associated with at least (i) a Timestamp of the newest set group of bits in the filter (ii) a Timestamp of the oldest set group of bits in the filter and (iii) Number of bits in the bloom filter representative of a probable false positive write indication, and wherein said computer processor is configured to determine an active bloom filter of said at least one bloom filter based on said number of bits representative of a false positive write indication.

5. The system according to claim 4, said computer processor being configured to determine an active bloom filter if the number of bits representative of a false positive write indication in a previous active bloom filter is larger than Z, where Z is calculated to guarantee error probability that is not less than a given value.

6. The system according to claim 5, wherein said given value is selected from a range of 15-30%.

7. A system comprising:
a computerized device configured for finding differences between two periodical snapshots; the computerized device comprising at least one computer processor operatively connected to a computer data storage;
data indicative of a coarse grain data structure corresponding to the given logical unit and including a plurality of entries wherein each entry is representative of a write or no-write operation to a respective memory chunk of a first granularity in said logical unit; each memory chunk includes a plurality of blocks each of a second granularity that is considerably finer than said first granularity;
data indicative of at least one bloom filter, each bloom filter including a plurality of bits wherein each group of bits is representative of a probable false positive write indication or no-write operation to a block in said chunk;
the data structure is further configured to store data including a plurality of periodic snapshotsᵢ and associated said coarse grain data structure obtained at respective timestamp tᵢ;
the computer processor is configured to:
(ii) in response to a request to compare between at least two periodic snapshots: an older snapshotⱼ and a younger snapshotₖ obtained at respective older timestamp tⱼ and younger timestamp tₖ, includes performing:
(b) for the coarse grain data structure that is associated with the younger snapshotₖ: with respect to each entry that is representative of a write in a memory chunk, includes performing:
1. with respect to each block of said chunk, test in at least one selected bloom filter of said at least one bloom filter if the corresponding group of bits is representative of a false positive, and provide “possible snapshots difference” indication.

8. The system according to claim 7, wherein said (a) further includes: in case all the entries of said coarse grain data structure are representative of “no write” in said memory chunk, provide “no snapshots difference” indication.

9. The system according to claim 7, wherein each one of said at least one bloom filter is associated with a corresponding timestamp_{MIN} and timestamp_{MAX} and said bloom filter is selected if timestamp_{MIN}≤tₖ≤timestamp_{MAX}.

10. The system according to claim 7, wherein said possible snapshots difference indication includes performing: extract said older snapshotⱼ and said younger snapshotₖ and compare them to provide indication on whether they are identical or different.

11. The system according to claim 7, for finding differences between two periodical snapshots, further includes:
in response to a request to compare between two periodical snapshots in a series of snapshots extending over an oldest snapshot₁ and a youngest snapshot_{N} obtained at respective oldest timestamp and youngest timestamp t_{N}, perform comparison between said older snapshotⱼ and said younger snapshotₖ, where 1<k<N and j=k−1, wherein the coarse grain data structure that is associated with the younger snapshotₖ: has an entry that is representative of a write in a memory chunk, and the respective entry in the coarse grain data structure that is associated with each snapshotᵢ (where 1≤i≤k−1) is representative of a no write in said memory chunk.

12. A system comprising:
a computerized device configured for finding differences between a given block in two periodical snapshots; the computerized device comprising at least one computer processor operatively connected to a computer data storage;
data indicative of a coarse grain data structure corresponding to the given logical unit and including a plurality of entries wherein each entry is representative of a write or no-write operation to a respective memory chunk of a first granularity in said logical unit; each memory chunk includes a plurality of blocks each of a second granularity that is considerably finer than said first granularity;
data indicative of at least one bloom filter, each bloom filter includes a plurality of bits wherein each group of bits is representative of a probable false positive write indication or no-write operation to a block in said chunk;
the data structure is further configured to store data including a plurality of periodic snapshotsᵢ and associated said coarse grain data structure obtained at respective timestamp tᵢ;
the computer processor is configured to:
(a) in response to a request to compare between said given block in at least two periodic snapshots: an older snapshotⱼ and a younger snapshotₖ obtained at respective older timestamp tⱼ and younger timestamp tₖ, includes performing:
2. with respect to said block in a chunk, test in at least one selected bloom filter of said at least one bloom filter if the corresponding group of bits is representative of a false positive, and provide “possible snapshots difference” indication.

13. The system according to claim 12, wherein said processor is configured to perform said (a) with respect to each of at least one other block in said two periodic snapshots.

14. The system according to claim 12, wherein said (a) further includes:
in case said group of bits all are representative of “no write” in said block, provide “no block difference” indication.

15. The system according to claim 12, wherein each one of said at least one bloom filter is associated with a corresponding timestamp_{MIN} and timestamp_{MAX} and said bloom filter is selected if timestamp_{MIN}≤tₖ≤timestamp_{MAX}.

16. The system according to claim 12, wherein said possible snapshots difference indication includes performing: extract said older snapshotⱼ and a younger snapshotₖ and compare the block in the snapshots to provide indication on whether the block in the snapshots is identical or different.

17. A system comprising:
a computerized device configured for finding differences between two periodical snapshots; the computerized device comprising at least one computer processor operatively connected to a computer data storage;
data indicative of a coarse grain data structure corresponding to the given logical unit and including a plurality of entries, wherein each entry is representative of a write or no-write operation to a respective memory chunk of a first granularity in said logical unit; each memory chunk includes a plurality of blocks each of a second granularity that is considerably finer than said first granularity;
data indicative of at least one bloom filter, each bloom filter including a plurality of bits wherein each group of bits is representative of a probable false positive write indication or no-write operation to a block in said chunk;
wherein the memory space allocated to said coarse grain data structure and said bloom filter is significantly smaller than a memory space that would have been allocated to a reference coarse grain data structure, where each entry in said reference coarse grain data structure corresponds to a block in said logical unit;
the data structure is further configured to store data including a plurality of periodic snapshotsᵢ and associated coarse data structure obtained at respective timestamp tᵢ;
the computer processor is configured to:
(ii) in response to a request to compare between at least two periodic snapshots: an older snapshotⱼ and a younger snapshotₖ obtained at respective older timestamp tⱼ and younger timestamp tₖ, includes performing:
utilize the coarse data structure associated with said older snapshotⱼ and a younger snapshotₖ and an active bloom filter for determining the likelihood of difference between said older snapshotⱼ and younger snapshotₖ in a considerably more efficient computational complexity compared to tedious block-wise comparison between said older snapshotⱼ and a younger snapshotₖ.

18. The system according to claim 17, wherein said computer processor is configured to determine an active bloom filter if the number of bits representative of a probable false positive write indication of a previous active bloom filter is larger than Z, where Z is calculated to guarantee error probability that is not less than a given value.

19. The system according to claim 5, wherein said given value is selected from a range of 15-30%.

20. A method for finding differences between two periodical snapshots, by at least one computer processor operatively connected to a computer data storage, comprising:
(v) providing data indicative of a coarse grain data structure corresponding to a given logical unit and including a plurality of entries, wherein each entry is representative of a write or no-write operation to a respective memory chunk of a first granularity in said logical unit; each memory chunk includes a plurality of blocks each of a second granularity that is considerably finer than said first granularity;
(vi) providing data indicative of at least one bloom filter, each bloom filter including a plurality of bits, wherein each group of bits is representative of a probable false positive write indication or no-write operation to a block in said chunk; each bloom filter is associated with min timestamp and max timestamp;
the method further comprising:
(vii) in response to a write operation performed to a block in a memory chunk constituting a written block in a written memory chunk of a given logical unit,
a. set in the coarse grain data structure that corresponds to said logical unit, the value of the entry that corresponds to said written memory chunk to be representative of a write operation; and
b. set in an active bloom filter of said at least one bloom filter that corresponds to said logical unit, the value of the group of bits that corresponds to said written block being representative of a probable false positive write indication;
the method further comprising:
(viii) in response to obtaining a periodic snapshotᵢ of said logical unit at a timestamp tᵢ:
b. store at least the periodic snapshotᵢ, said data representative of the coarse grain data structure at said timestamp tᵢ and said timestamp tᵢ;
thereby facilitating usage of said course grain data structure at said timestamp tᵢ and a bloom filter of said at least one bloom filter for determining differences between snapshots.

21. A method for finding differences between two periodical snapshots, by at least one computer processor operatively connected to a computer data storage, comprising:
(V) providing data indicative of a coarse grain data structure corresponding to the given logical unit and including a plurality of entries wherein each entry is representative of a write or no-write operation to a respective memory chunk of a first granularity in said logical unit; each memory chunk includes a plurality of blocks each of a second granularity that is considerably finer than said first granularity;
(VI) providing data indicative of at least one bloom filter, each bloom filter including a plurality of bits wherein each group of bits is representative of a probable false positive write indication or no-write operation to a block in said chunk;
(VII) store data including a plurality of periodic snapshotsᵢ and associated said coarse grain data structure obtained at respective timestamp tᵢ;
the method further comprising:
(VIII) in response to a request to compare between at least two periodic snapshots: an older snapshotⱼ and a younger snapshotₖ obtained at respective older timestamp tⱼ and younger timestamp tₖ, includes performing:
(b) for the coarse grain data structure that is associated with the younger snapshotₖ: with respect to each entry that is representative of a write in a memory chunk, includes performing:
(i) with respect to each block of said chunk, test in at least one selected bloom filter of said at least one bloom filter if the corresponding group of bits is representative of a false positive, and provide “possible snapshots difference” indication.

22. A method for finding differences between a given block in two periodical snapshots, by at least one computer processor operatively connected to a computer data storage, comprising:
(V) providing data indicative of a coarse grain data structure corresponding to the given logical unit and including a plurality of entries wherein each entry is representative of a write or no-write operation to a respective memory chunk of a first granularity in said logical unit; each memory chunk includes a plurality of blocks each of a second granularity that is considerably finer than said first granularity;
(VI) providing data indicative of at least one bloom filter, each bloom filter includes a plurality of bits wherein each group of bits is representative of a probable false positive write indication or no-write operation to a block in said chunk;
(VII) store data including a plurality of periodic snapshotsᵢ and associated said coarse grain data structure obtained at respective timestamp tᵢ;
the method further comprising:
(VIII) in response to a request to compare between said given block in at least two periodic snapshots: an older snapshotⱼ and a younger snapshotₖ obtained at respective older timestamp tⱼ and younger timestamp tₖ, includes performing:
1. with respect to said block in a chunk, test in at least one selected bloom filter of said at least one bloom filter if the corresponding group of bits is representative of a false positive, and provide “possible snapshots difference” indication.

23. A method for finding differences between two periodical snapshots, by at least one computer processor operatively connected to a computer data storage, comprising:
(j) data indicative of a coarse grain data structure corresponding to the given logical unit and including a plurality of entries, wherein each entry is representative of a write or no-write operation to a respective memory chunk of a first granularity in said logical unit; each memory chunk includes a plurality of blocks each of a second granularity that is considerably finer than said first granularity;
(ii) providing data indicative of at least one bloom filter, each bloom filter including a plurality of bits wherein each group of bits is representative of a probable false positive write indication or no-write operation to a block in said chunk; wherein the memory space allocated to said coarse grain data structure and said bloom filter is significantly smaller than a memory space that would have been allocated to a reference coarse grain data structure, where each entry in said reference coarse grain data structure corresponds to a block in said logical unit;
(iii) store data including a plurality of periodic snapshotsᵢ and associated coarse data structure obtained at respective timestamp tᵢ;
the method further comprising:
(iv) in response to a request to compare between at least two periodic snapshots: an older snapshotⱼ and a younger snapshotₖ obtained at respective older timestamp tⱼ and younger timestamp tₖ, includes performing:
utilize the coarse data structure associated with said older snapshotⱼ and a younger snapshotₖ and an active bloom filter for determining the likelihood of difference between said older snapshotⱼ and younger snapshotₖ in a considerably more efficient computational complexity compared to tedious block-wise comparison between said older snapshotⱼ and a younger snapshotₖ.

24. A machine-readable non-transitory memory tangibly embodying a program of instructions executable by a processor for executing the method of claim 20.

25. A machine-readable non-transitory memory tangibly embodying a program of instructions executable by a processor for executing the method of claim 21.

26. A machine-readable non-transitory memory tangibly embodying a program of instructions executable by a processor for executing the method of claim 22.

27. A machine-readable non-transitory memory tangibly embodying a program of instructions executable by a processor for executing the method of claim 23.
